(19) United States
(12) Patent Application Publication
(10) Pub. No.: US 2017/0110756 A1
(43) Pub. Date: Apr. 20, 2017

(54) SODIUM ION SECONDARY BATTERY

(71) Applicant: Sumitomo Electric Industries, Ltd., Osaka-shi (JP)

(72) Inventors: Koji Nitta, Osaka-shi (JP); Shoichiro Sakai, Osaka-shi (JP); Atsushi Fukunaga, Osaka-shi (JP); Eiko Imazaki, Osaka-shi (JP); Koma Numata, Osaka-shi (JP)

(21) Appl. No.: 15/317,868

(22) PCT Filed: Jun. 3, 2015
(86) PCT No.: PCT/JP2015/065979

§ 371 Date: Dec. 9, 2016

(30) Foreign Application Priority Data
Jun. 17, 2014 (JP) 2014-124596

(51) Int. Cl. H01M 10/054; H01M 4/134; H01M 4/583; H01M 4/525; H01M 4/505; H01M 4/40; H01M 4/131; H01M 4/133

(52) U.S. Cl. CPC H01M 10/054; H01M 4/131; H01M 4/134; H01M 4/133; H01M 4/525; H01M 4/505; H01M 4/40; H01M 4/583; H01M 2220/20

(57) ABSTRACT

A sodium ion secondary battery includes a positive electrode containing a positive electrode active material, a negative electrode containing a negative electrode active material, a separator provided between the positive electrode and the negative electrode, and an electrolyte, the positive electrode active material containing a sodium-containing transition metal oxide that reversibly intercalates and deintercalates sodium ions, in the sodium-containing transition metal oxide in a fully charged state, the ratio of sodium atoms to transition metal atoms, i.e., Na/M_{T}, satisfying Na/M_{T}≦0.3, and the ratio of the total Cₙₜ of the reversible capacity and the irreversible capacity of the negative electrode to the total Cₚₜ of the reversible capacity and the irreversible capacity of the positive electrode, i.e., Cₙₜ/Cₚₜ, satisfying 1≦Cₙₜ/Cₚₜ.

### TECHNICAL FIELD

The present invention relates to a sodium ion secondary battery containing a sodium-containing transition metal oxide serving as a positive electrode active material, the sodium-containing transition metal oxide reversibly carrying sodium ions.

### BACKGROUND ART

In recent years, techniques for converting natural energy into electrical energy have been receiving attention. There has been increasing demand for nonaqueous electrolyte secondary batteries serving as high-energy-density batteries capable of storing a large amount of electrical energy. Among nonaqueous electrolyte secondary batteries, lithium-ion secondary batteries have the advantage of being light in weight and having high electromotive forces. However, the price of lithium resources is rising in association with the expansion of the market for nonaqueous electrolyte secondary batteries.

There have been advances in the development of sodium ion secondary batteries containing sodium, which is inexpensive. Molten salt batteries containing molten salts that contain sodium ions are also promising. Sodium ion secondary batteries use sodium ions; hence, sodium ion secondary batteries is produced at low cost, have good thermal stability, relatively easily ensure safety, and are suited for continuous use at high temperatures.

PTL 1 discloses a sodium molten salt battery containing a sodium-containing transition metal oxide that serves as a positive electrode active material and a sodium ion-containing molten salt that serves as an electrolyte.

### CITATION LIST

### Patent Literature

PTL 1: Japanese Unexamined Patent Application Publication No. 2012-182087

### SUMMARY OF INVENTION

### Technical Problem

In a sodium ion secondary battery, such as a sodium molten salt battery, charge and discharge are performed by repeating the intercalation and deintercalation of sodium ions with active materials of a positive electrode and a negative electrode. However, in an overcharged state, the number of sodium ions corresponding to the irreversible capacity, which is not deintercalated from the positive electrode active material during normal charge and discharge, is deintercalated. Thus, a negative electrode active material cannot completely intercalate many sodium ions, thereby easily causing the deposition of sodium.

It is an object to inhibit the deposition of sodium in a sodium ion secondary battery during overcharge.

### Solution to Problem

An aspect of the present invention relates to a sodium ion secondary battery including a positive electrode containing a positive electrode active material, a negative electrode containing a negative electrode active material, a separator provided between the positive electrode and the negative electrode, and an electrolyte,

the electrolyte being a nonaqueous electrolyte containing sodium ions,

the positive electrode active material containing a sodium-containing transition metal oxide that reversibly intercalates and deintercalates sodium ions,

the negative electrode active material containing at least one selected from the group consisting of a first material that reversibly intercalates and deintercalates sodium ions and a second material that is alloyed with sodium,

in the sodium-containing transition metal oxide in a fully charged state, the ratio of sodium atoms to transition metal atoms, i.e., Na/M_{T}, satisfying Na/M_{T}≦0.3, and
the ratio of the total Cₙₜ of the reversible capacity and the irreversible capacity of the negative electrode to the total Cₚₜ of the reversible capacity and the irreversible capacity of the positive electrode, i.e., Cₙₜ/Cₚₜ, satisfying 1≦Cₙₜ/Cₚₜ.

### Advantageous Effects of Invention

In the sodium ion secondary battery, the deposition of sodium is inhibited even during overcharge.

### BRIEF DESCRIPTION OF DRAWINGS

FIG. 1 is a longitudinal sectional view schematically illustrating a sodium ion secondary battery according to an embodiment of the present invention.

FIG. 2 is a block diagram schematically illustrating a charge-discharge system including a sodium ion secondary battery according to an embodiment of the present invention.

### DESCRIPTION OF EMBODIMENTS

### Description of Embodiments of Invention

First, embodiments of the present invention will be listed and described below.

A sodium ion secondary battery according to an embodiment of the present invention includes (1) a positive electrode containing a positive electrode active material, a negative electrode containing a negative electrode active material, a separator provided between the positive electrode and the negative electrode, and an electrolyte. The electrolyte is a nonaqueous electrolyte containing sodium ions. The positive electrode active material contains a sodium-containing transition metal oxide that reversibly intercalates and deintercalates sodium ions. The negative electrode active material contains at least one selected from the group consisting of a first material that reversibly intercalates and deintercalates sodium ions and a second material that is alloyed with sodium. In the sodium-containing transition metal oxide in a fully charged state, the ratio of sodium atoms to transition metal atoms, i.e., Na/M_{T}, satisfies Na/M_{T}≦0.3. The ratio of the total Cₙₜ of the reversible capacity and the irreversible capacity of the negative electrode to the total Cₚₜ of the reversible capacity and the irreversible capacity of the positive electrode, i.e., Cₙₜ/Cₚₜ, satisfies 1≦Cₙₜ/Cₚₜ.

As described above, in this embodiment, the sodium-containing transition metal oxide satisfying the ratio Na/M_{T}≦0.3 in the fully charged state is used as the positive electrode active material. In other words, the positive electrode active material that can be charged and discharged reversibly and deeply is used; hence, the irreversible capacity of the positive electrode is reduced. Furthermore, the total Cₙₜ of the reversible capacity and the irreversible capacity of the negative electrode is equal to or higher than the total Cₚₜ of the reversible capacity and the irreversible capacity of the positive electrode. Thus, even if the number of sodium ions corresponding to the irreversible capacity is completely deintercalated from the positive electrode active material during overcharge, the sodium ions are stably intercalated or alloyed in the negative electrode. Accordingly, the deposition of sodium is inhibited. The use of the positive electrode active material as described above also increases the energy density.

The fully charged state means a state in which the state of charge (SOC) of a sodium ion secondary battery is 100%, in other words, a state in which the sodium ion secondary battery is charged to a predetermined charge cut-off voltage within the range in which reversible charge and discharge are performed. The charge cut-off voltage is one of the battery characteristics of a sodium ion secondary battery and set by a manufacturer, depending on, for example, the type of active material. A sodium ion secondary battery is typically controlled by a voltage control circuit, such as a charger, so as not to be charged to a voltage higher than the predetermined charge cut-off voltage (in other words, a state of charge exceeding 100%). However, the battery can be overcharged because of, for example, the deterioration or fault of a charger, and/or improper use by a user. In embodiments of the present invention, the fully charged state (SOC: 100%) is set in such a manner that the ratio Na/M_{T} in the fully charged state satisfies Na/M_{T}≦0.3.

When Na/M_{T}≦0.3 is satisfied, Na/M_{T} can satisfy Na/M_{T}≦0. In the present invention, the transition metal oxide contained in the positive electrode active material is fundamentally a sodium-containing transition metal oxide. Thus, even in the case where charge and discharge change Na/M_{T} and where a state in which Na/M_{T}≦0 is included, the transition metal oxide contained in the positive electrode active material is referred to as a “sodium-containing transition metal oxide”.

The total Cₙₜ of the reversible capacity and the irreversible capacity of the negative electrode may be determined by producing a half cell including a metallic sodium counter electrode and performing charge and discharge.

The total Cₚₜ of the reversible capacity and the irreversible capacity of the positive electrode may be estimated as a capacity when all sodium atoms are deintercalated from the positive electrode. In this specification, the irreversible capacity of the positive electrode can contain the buffer capacity.

(2) The sodium-containing transition metal oxide preferably contains Ni, Ti, and Mn as the transition metal atoms. The sodium-containing transition metal oxide tends to have small irreversible capacity.

(3) In a preferred embodiment, the sodium-containing transition metal oxide is a compound represented by formula (1): NaₓTi_{y}Ni_{z}Mn_{1-y-z}O₂ (where x varies by charge and discharge and satisfies 0≦x≦0.67; 0.15≦y≦0.2; and 0.3≦z≦0.35). The compound, in particular, has small irreversible capacity and high energy density.

In formula (1), the range of x that varies by charge and discharge includes x=0. In this case, the compound represented by formula (1) is referred to as the sodium-containing transition metal oxide. x may be in the range of 0<x≦0.67.

(4) The ratio Cₙₜ/Cₚₜ preferably satisfies 1≦Cₙₜ/Cₚₜ≦1.3. In this case, an excessively increase in the capacity (and volume) of the negative electrode that does not contribute to normal charge and discharge (that is, reversible charge and discharge) is inhibited while resistance to overcharge is enhanced, thus further increasing the energy density.

(5) When a capacity corresponding to the total number of sodium ions contained in the electrolyte is expressed as Cₑ, Cₙₜ preferably satisfies Cₙₜ≧(Cₚₜ+Cₑ). The progress of overcharge can terminate the deintercalation of sodium ions from the positive electrode to allow a side reaction or the like to proceed at the positive electrode. A charge reaction occurs at the negative electrode even while the side reaction proceeds at the positive electrode, so that sodium ions in the electrolyte are intercalated or alloyed with the negative electrode. The electrolyte contains a large number of sodium ions, thus leading to a state in which sodium is easily deposited. Even in this state, when Cₙₜ≧(Cₚₜ+Cₑ) is satisfied, the deposition of sodium is effectively inhibited.

Cₑ corresponds to the capacity of the negative electrode (or the positive electrode) with which all sodium ions contained in the electrolyte are intercalated or alloyed.

(6) Preferably, the electrolyte contains 70% by mass or more of an ionic liquid, and the ionic liquid contains an anion and a sodium ion. Such electrolytes are also called as molten salt electrolytes. Molten salt electrolytes having high ionic liquid contents as described above have high viscosity, so that sodium ions do not move easily (that is, low ionic conductivity). Thus, in particular, the deposition of sodium is liable to occur in batteries. In embodiment of the present invention, even when a molten salt electrolyte, in which the marked deposition of sodium is liable to occur, is used, the deposition of sodium is inhibited during overcharge. Thus, the sodium ion secondary battery (sodium molten salt battery) has good resistance to overcharge.

Molten salt batteries refer to batteries including molten salt electrolytes. Molten salt electrolytes refer to electrolytes mainly composed of ionic liquids. In the foregoing embodiment, the molten salt electrolyte contains 70% by mass or more of an ionic liquid. The ionic liquid is defined as a salt in a molten state (molten salt) and is a liquid ionic substance containing an anion and a cation. The sodium molten salt battery refers to a battery containing a sodium-ion-conducting molten salt as an electrolyte, sodium ions serving as charge carriers that participate in charge-discharge reactions.

(7) The first material is preferably at least one selected from the group consisting of soft carbon, hard carbon, and alkali metal-containing titanium oxide. The second material preferably contains at least one selected from the group consisting of zinc, indium, tin, silicon, phosphorus, antimony, lead, and bismuth. In these materials, the intercalation and deintercalation of sodium ions are stably performed. Alternatively, the alloying of sodium and dealloying are stably performed. Thus, these materials are suitable for the sodium ion secondary battery according to embodiments of the present invention.

### Details of Embodiments of Invention

Specific examples of a sodium ion secondary battery according to embodiments of the present invention will be described below with appropriate reference to the drawing. The present invention is not limited to these examples. It is intended to include any modifications within the scope and meaning equivalent to the scope of the claims.

The sodium ion secondary battery includes a positive electrode, a negative electrode, a separator provided between the positive electrode and the negative electrode, and an electrolyte containing sodium ions.

Elements of the sodium ion secondary battery will be described in further detail below.

### (Positive Electrode)

### (Positive Electrode Active Material)

A positive electrode active material in the positive electrode contains a sodium-containing transition metal oxide. The capacity of the sodium-containing transition metal oxide is provided by Faradaic reactions in which sodium ions are electrochemically intercalated and deintercalated. In the sodium-containing transition metal oxide in a state of charge (SOC) of 100%, the ratio Na/M_{T} satisfies Na/M_{T}≦0.3. The Na/M_{T} is the ratio of sodium atoms to transition metal atoms in the sodium-containing transition metal oxide in the state of charge (SOC) of 100%.

For example, sodium chromite (NaCrO₂) may be used as a positive electrode active material that reversibly intercalates and deintercalates sodium ions in a sodium ion secondary battery. In the case of sodium chromite, however, even if the fully charged state (SOC: 100%) is set in such a manner that the ratio Na/M_{T} is minimized within the range in which reversible charge and discharge are performed, the ratio Na/M_{T} is about 0.5 at a state of charge (SOC) of 100%. The active material has relatively large irreversible capacity. Thus, a large number of sodium ions are readily deintercalated during overcharge, so that the marked deposition of sodium is liable to occur. To reliably prevent the deposition of sodium during overcharge, the negative electrode needs to have capacity corresponding to the irreversible capacity of the positive electrode. If the capacity of the negative electrode is excessively increased in order to strike a capacity balance between the positive electrode and the negative electrode, the energy density is markedly reduced. It is thus realistic to usually set the capacity of the negative electrode to about 1.1 to about 1.2 times the reversible capacity of the positive electrode.

In embodiment of the present invention, in contrast, a positive electrode active material containing the sodium-containing transition metal oxide in which the ratio Na/M_{T} is 0.3 or less at a state of charge (SOC) of 100%, i.e., a positive electrode active material having small irreversible capacity, is used. Thus, the number of sodium ions deintercalated from the positive electrode active material during overcharge is reduced. Even though an excessively large negative electrode is not used, the deposition of sodium ions is inhibited. Furthermore, the use of the sodium-containing transition metal oxide described above also increases the depth of reversible charge and discharge, thereby increasing the energy density.

In theory, the ratio Na/M_{T} is relatively lowered as the proportion of the transition metal atoms in the sodium-containing transition metal oxide is increased. However, in fact, the proportion of the transition metal atoms in the sodium-containing transition metal oxide is substantially constant. Thus, the ratio Na/M_{T} (in particular, in the case of a P2-type layered or O3-type layered crystal structure) may be regarded as the proportion of Na in the sodium-containing transition metal oxide.

In a state of charge (SOC) of 100%, the ratio Na/M_{T} is 0.3 or less and may be 0.2 or less or 0.1 or less. When the ratio Na/M_{T} is reduced, the irreversible capacity of the sodium-containing transition metal oxide (by extension, the irreversible capacity of the positive electrode active material and the positive electrode) is reduced, thus enhancing the effect of inhibiting the deposition of sodium during overcharge. Furthermore, the energy density is increased. The ratio Na/M_{T} in a state of charge (SOC) of 100% satisfies 0≦Na/M_{T} and may satisfy 0<Na/M_{T}, 0.05≦Na/M_{T}, or 0.1≦Na/M_{T}. The upper limit values and the lower limit values may be freely combined together. The ratio Na/M_{T} in a state of charge (SOC) of 100% may satisfy 0≦Na/M_{T}≦0.3, 0≦Na/M_{T}≦0.2, 0.05≦Na/M_{T}≦0.3, or 0.1≦Na/MT≦0.3.

The transition metal element contained in the sodium-containing transition metal oxide is at least one (preferably at least two) selected from the group consisting of Ti, V, Mn, Fe, Co, and Ni. The transition metal element may further contain Cr, as needed. As the sodium-containing transition metal oxide, a material containing Ni, Ti, and Mn as transition metal atoms is preferred. Other transition metal atoms (V, Fe, Co, and/or Cr) and/or other atoms (main-group elements and so forth) may be contained, as needed.

The sodium-containing transition metal oxide containing Ni, Ti, and Mn tends to have small reversible capacity and thus is advantageous in that the ratio Na/M_{T} is reduced at a state of charge (SOC) of 100%. In particular, the use of a compound represented by formula (1): NaₓTi_{y}Ni_{z}Mn_{1-y-z}O₂ (x varies by charge and discharge and satisfies 0≦x≦0.67; 0.15≦y≦0.2, and 0.3≦z≦0.35) as the sodium-containing transition metal oxide is particularly advantageous in that the ratio Na/M_{T} is reduced at a state of charge (SOC) of 100%.

The compound represented by formula (1) tends to have a crystal structure of Na_{2/3}Ti_{1/6}Ni_{1/3}Mn_{1/2}O₂ (that is, a P2-type layered structure). Thus, charge and discharge are stably performed.

The proportion x of sodium atoms is increased during discharge and reduced during charge. The proportion x of sodium atoms at a state of charge (SOC) of 100% corresponds to the ratio Na/M_{T} at a state of charge (SOC) of 100% (the proportion x of sodium atoms corresponds to the ratio Na/M_{T} of sodium atoms to transition metal atoms).

The sodium-containing transition metal oxide also includes a compound in which at least one of Ti, Ni, and Mn in formula (1) is replaced with the other transition metal atoms, a main-group element, or the like.

A single type of the sodium-containing transition metal oxide may be used alone. Alternatively, two or more types of the sodium-containing transition metal oxides may be used in combination. Among compounds represented by formula (1), NaₓTi_{1/6}Ni_{1/3}Mn_{1/2}O₂ is preferred because of its small irreversible capacity and high energy density.

The sodium-containing transition metal oxide may be prepared by a known method. The sodium-containing transition metal oxide may be prepared by, for example, a method in which a mixture of a Na compound (for example, oxide, hydroxide, and/or carbonate) and a transition metal compound (for example, oxide, hydroxide, and/or carbonate) is fired in an inert gas atmosphere. In the case where the sodium-containing transition metal oxide contains multiple types of transition metal atoms, multiple compounds containing respective transition metal atoms may be used. Alternatively, a compound (for example, a composite oxide) containing multiple transition metal atoms may be used.

The positive electrode active material may contain an active material other than the sodium-containing transition metal oxide (specifically, a material that reversibly intercalates and deintercalates sodium ions), as needed. The proportion of the sodium-containing transition metal oxide in the positive electrode active material is, for example, 80% to 100% by mass and preferably 90% to 100% by mass. The positive electrode active material may be composed of the sodium-containing transition metal oxide alone.

### (Others)

The ratio of the total Cₙₜ of the reversible capacity and the irreversible capacity of the negative electrode to the total Cₚₜ of the reversible capacity and the irreversible capacity of the positive electrode, i.e., Cₙₜ/Cₚₜ, satisfies 1≦Cₙₜ/Cₚₜ. An increase in ratio Cₙₜ/Cₚₜ has a tendency to improve overcharge resistance characteristics. However, an excessive increase in ratio Cₙₜ/Cₚₜ requires the use of a negative electrode having larger capacity prepared for the irreversible capacity of the positive electrode, leading to a larger volume of the negative electrode that is not used for reversible charge and discharge (normal charge and discharge) in the battery.

Thus, from the viewpoint of increasing the energy density of the battery, the ratio Cₙₜ/Cₚₜ is preferably, for example, 1.5 or less and may be 1.4 or less or 1.3 or less. The ratio Cₙₜ/Cₚₜ may satisfy 1≦Cₙₜ/Cₚₜ, 1<Cₙₜ/Cₚₜ, or 1.1≦Cₙₜ/Cₚₜ. These upper limit values and the lower limit values may be freely combined together. The ratio Cₙₜ/Cₚₜ may satisfy, for example, 1≦Cₙₜ/Cₚₜ≦1.5, 1≦Cₙₜ/Cₚₜ≦1.3, 1<Cₙₜ/Cₚₜ≦1.3, 1.1≦Cₙₜ/Cₚₜ≦1.5, or 1.1≦Cₙₜ/Cₚₜ≦1.3.

The positive electrode may contain the positive electrode active material (or a positive electrode mixture containing the positive electrode active material) and a positive electrode current collector carrying the positive electrode active material (or the positive electrode mixture).

The positive electrode current collector may be formed of metal foil or a metal porous body (a nonwoven fabric formed of metal fibers and/or a metal porous sheet). As the metal porous body, a metal porous body having a three-dimensional mesh-like skeleton (in particular, a hollow skeleton) may be used. The material of the positive electrode current collector is, but not particularly limited to, for example, preferably aluminum and/or an aluminum alloy in view of stability at a positive electrode potential. The metal foil has a thickness of, for example, 10 to 50 μm. The metal porous body has a thickness of, for example, 100 to 2000 μm.

The positive electrode mixture may further contain a conductive assistant and/or a binder, in addition to the positive electrode active material. The positive electrode may be formed by applying or charging the positive electrode mixture into the positive electrode current collector, performing drying, and optionally, performing pressing (or rolling) in the thickness direction. The positive electrode mixture is typically used in the form of a slurry containing a dispersion medium. As the dispersion medium, an organic solvent, such as N-methyl-2-pyrrolidone (NMP) and/or water is used.

Examples of the conductive assistant include, but are not particularly limited to, carbon black, graphite, carbon fibers (for example, vapor-grown carbon fibers), and/or carbon nanotubes. From the viewpoint of increasing conductivity, particles of the positive electrode active material may be covered with the conductive assistant. The covering with the conductive assistant may be performed by the application of the conductive assistant to surfaces of the particles of the positive electrode active material, mechanochemical processing (including mechanofusion processing), or the like.

The amount of the conductive assistant may be appropriately selected in the range of, for example, 1 to 25 parts by mass and may be 5 to 20 parts by mass with respect to 100 parts by mass of the positive electrode active material.

Examples of the binder include, but are not particularly limited to, fluororesins, such as polyvinylidene fluoride and polytetrafluoroethylene; polyolefin resins; rubbery polymers, such as styrene-butadiene rubber; polyamide resins (for example, aromatic polyamide); polyimide resins, such as polyimide and polyamide-imide; polyvinylpyrrolidone; polyvinyl alcohol; and/or cellulose ether (carboxyalkyl cellulose and salts thereof, such as carboxymethyl cellulose and sodium salts thereof).

The amount of the binder may be selected in the range of, but is not particularly limited to, for example, about 0.5 to about 15 parts by mass and may be preferably 1 to 12 parts by mass with respect to 100 parts by mass of the positive electrode active material from the viewpoint of easily ensuring high binding properties and capacity.

### (Negative Electrode)

The negative electrode contains a negative electrode active material. The negative electrode may contain a negative electrode current collector and the negative electrode active material (or a negative electrode mixture) carried on the negative electrode current collector.

The negative electrode current collector may be formed of metal foil or a metal porous body as those described in the positive electrode current collector. Preferred examples of a material for the negative electrode current collector include, but are not particularly limited to, copper, copper alloys, nickel, nickel alloys, and stainless steel because they are not alloyed with sodium and are stable at a negative electrode potential. The thickness of the negative electrode current collector may be appropriately selected in the range described in the positive electrode current collector.

Examples of the negative electrode active material include materials that reversibly carry sodium ions. Examples of the materials include a material (first material) that reversibly intercalates and deintercalates sodium ions; and a material (second material) that is alloyed with sodium (specifically, reversible alloying and dealloying). Each of the first material and the second material is a material whose capacity is provided by Faradaic reactions.

Examples of the first material include carbonaceous materials and/or metal compounds. Examples of the carbonaceous materials include graphitizable carbon (soft carbon) and/or non-graphitizable carbon (hard carbon). Examples of the metal compounds include titanium compounds, such as lithium-containing titanium oxide, e.g., lithium titanate (for example, Li₂Ti₃O₇ and/or Li₄Ti₅O₁₂); and sodium-containing titanium oxide (e.g., alkali metal-containing titanium oxide), such as sodium titanate (for example, Na₂Ti₃O₇ and/or Na₄Ti₅O₁₂). In the lithium-containing titanium oxide (or the sodium-containing titanium oxide), titanium and/or lithium (or sodium) may be partially replaced with another element. As the first material, at least one selected from the group consisting of soft carbon, hard carbon, and alkali metal-containing titanium oxide may be used.

Examples of the second material include a material containing at least one selected from the group consisting of zinc, indium, tin, silicon, phosphorus, antimony, lead, and bismuth. Examples of the material include metals, alloys, and compounds containing the foregoing elements.

A single type of the negative electrode active material may be used alone. Alternatively, two or more types of the negative electrode active materials may be used in combination. Among these materials, the first material, for example, the foregoing compound (such as sodium-containing titanium oxide) and/or the carbonaceous material (such as hard carbon) is preferred from the viewpoint of easily achieving high energy density.

Cₙₜ may be equal to or larger than Cₚₜ. From the viewpoint of further effectively inhibiting the deposition of sodium ions during overcharge, Cₙₜ≧(Cₚₜ+Cₑ) is preferred. In this case, even if overcharge proceeds to cause a state in which sodium ions in the electrolyte participate in charge, sodium ions are intercalated or alloyed with the negative electrode.

Cₑ is, for example, 0.01 mAh to 1×Cₚₜ mAh and may be 0.1 mAh to 1 mAh or 0.2 mAh to 0.8 mAh.

As with the case of the positive electrode, the negative electrode may be formed by, for example, applying or charging the negative electrode mixture containing the negative electrode active material into the negative electrode current collector, performing drying, and optionally, performing pressing (or rolling) in the thickness direction. As the negative electrode, a component produced by depositing a film of the negative electrode active material on a surface of the negative electrode current collector using a gas-phase method, for example, evaporation or sputtering may be used. A sheet-like metal or alloy may be directly used as the negative electrode. A component produced by press-bonding the sheet-like metal or alloy to a current collector may be used as the negative electrode.

The negative electrode mixture may further contain a conductive assistant and/or a binder, in addition to the negative electrode active material. The binder (binding agent) and the conductive assistant may be appropriately selected from those exemplified for the positive electrode. The amounts of the binder (binding agent) and the conductive assistant for the negative electrode active material may be appropriately selected from the ranges exemplified for the positive electrode. The negative electrode mixture is typically used in the form of a slurry (or paste) containing a dispersion medium. The dispersion medium may be appropriately selected from those exemplified for the positive electrode.

### (Separator)

As the separator, for example, a microporous membrane composed of a resin and/or a nonwoven fabric may be used. The material of the separator may be selected in consideration of the operating temperature of the battery. Examples of the resin contained in fibers in the microporous membrane or nonwoven fabric include polyolefin resins, polyphenylene sulfide resins, polyamide resins (such as aromatic polyamide resins), and/or polyimide resins. The fibers contained in the nonwoven fabric may be inorganic fibers, such as glass fibers. The separator may contain an inorganic filler, such as ceramic particles.

The thickness of the separator is not particularly limited and may be selected in the range of, for example, about 10 to about 300 μm.

### (Electrolyte)

As the electrolyte, a nonaqueous electrolyte containing sodium ions is used. Examples of the nonaqueous electrolyte that is used include an electrolyte (organic electrolyte) in which a salt (sodium salt) of a sodium ion and an anion is dissolved in a nonaqueous solvent (organic solvent); and an ionic liquid (molten salt electrolyte) containing a cation (cation containing a sodium ion) and an anion.

An electrolyte containing the nonaqueous solvent (organic solvent) is preferably used in view of low-temperature properties and so forth. An electrolyte containing an ionic liquid is preferably used from the viewpoint of minimizing the decomposition of the electrolyte. An electrolyte containing the ionic liquid and the nonaqueous solvent may be used.

The concentration of a sodium salt or sodium ions in the electrolyte may be appropriately selected in the range of, for example, 0.3 to 10 mol/L.

### (Organic Electrolyte)

The organic electrolyte may contain, for example, an ionic liquid and/or an additive, in addition to the nonaqueous solvent (organic solvent) and the sodium salt. The total contents of the nonaqueous solvent and the sodium salt in the electrolyte is, for example, 60% by mass or more, preferably 75% by mass or more, and more preferably 85% by mass or more. The total contents of the nonaqueous solvent and the sodium salt in the electrolyte may be, for example, 100% by mass or less or 95% by mass or less. These lower limit values and the upper limit values may be freely combined together. The total contents of the nonaqueous solvent and the sodium salt in the electrolyte may be, for example, 60% to 100% by mass or 75% to 95% by mass.

Examples of the type of the anion (first anion) contained in the sodium salt include, but are not particularly limited to, anions of fluorine-containing acids [such as fluorine-containing phosphate anions, e.g., a hexafluorophosphate ion, and fluorine-containing borate anions, e.g., a tetrafluoroborate ion]; anions of chlorine-containing acids [such as a perchlorate ion]; anions of oxalate group-containing oxygen acids [such as oxalato borate ions, e.g., a bis(oxalato)borate ion (B(C₂O₄)₂⁻), and oxalato phosphate ions, e.g., a tris(oxalato)phosphate ion (P(C₂O₄)₃⁻)]; fluoroalkanesulfonate anions [such as a trifluoromethanesulfonate ion (CF₃SO₃⁻)]; and bis(sulfonyl)amide anions.

A single type of the sodium salt may be used alone. Alternatively, two or more types of the sodium salts having different first anions may be used in combination.

Examples of the bis(sulfonyl)amide anions include a bis(fluorosulfonyl)amide anion (FSA), a bis(trifluoromethylsulfonyl)amide anion (TFSA), a (fluorosulfonyl)(perfluoroalkylsulfonyl)amide anion [such as (FSO₂)(CF₃SO₂)N⁻], and a bis(perfluoroalkylsulfonyl)amide anion [such as N(SO₂CF₃)₂⁻ and N(SO₂C₂F₅)₂⁻]. Of these, in particular, FSA and/or TFSA is preferred.

The nonaqueous solvent is not particularly limited. Known nonaqueous solvents used for sodium ion secondary batteries may be used. Examples of the nonaqueous solvent that may be preferably used in view of ionic conductivity include cyclic carbonates, such as ethylene carbonate, propylene carbonate, and butylene carbonate; chain carbonates, such as dimethyl carbonate, diethyl carbonate, and ethyl methyl carbonate; and cyclic carbonate, such as γ-butyrolactone. A single type of the nonaqueous solvent may be used alone. Alternatively, two or more types of the nonaqueous solvents may be used in combination.

### (Molten Salt Electrolyte)

In the case where the molten salt electrolyte containing an ionic liquid is used as the electrolyte, the electrolyte may contain, for example, a nonaqueous solvent and/or an additive, in addition to the ionic liquid containing a cation and an anion. The electrolyte preferably has an ionic liquid content of 70% by mass or more. The ionic liquid content of the electrolyte is preferably 70% to 100% by mass and may be 80% to 100% by mass or 90% to 100% by mass. In this embodiment of the present invention, even in the case of high ionic liquid content, the deposition of sodium is inhibited during overcharge.

The molten salt electrolyte (or its cation) may contain a cation (third cation) other than a sodium ion, in addition to a sodium ion (second cation). Examples of the third cation include organic cations and inorganic cations other than a sodium ion. The molten salt electrolyte (or its cation) may contain a single type of the third cation or may contain two or more types of third cations in combination.

Examples of organic cations include cations derived from aliphatic amines, alicyclic amines, and aromatic amines (such as quaternary ammonium cations); nitrogen-containing onium cations, such as cations having nitrogen-containing heterocycles (i.e., cations derived from cyclic amines); sulfur-containing onium cations; and/or phosphorus-containing onium cations.

Among nitrogen-containing organic onium cations, in particular, a quaternary ammonium cation and a cation having a pyrrolidine, pyridine, or imidazole skeleton serving as a nitrogen-containing heterocyclic skeleton are preferred.

Specific examples of the nitrogen-containing organic onium cations include tetraalkylammonium cations, such as a tetraethylammonium cation (TEA) and a methyltriethylammonium cation (TEMA); 1-methyl-1-propylpyrrolidinium cation (MPPY or Py13) and 1-butyl-1-methylpyrrolidinium cation (MBPY or Py14); and/or 1-ethyl-3-methylimidazolium cation (EMI) and 1-butyl-3-methylimidazolium cation (BMI).

Examples of the inorganic cations include alkali metal ions other than a sodium ion (such as a potassium ion); alkaline-earth metal ions (such as a magnesium ion and a calcium ion); and/or an ammonium ion.

The molten salt electrolyte (or its cation) preferably contains an organic cation. The use of the organic cation-containing ionic liquid reduces the melting point and/or viscosity of the molten salt electrolyte. This easily increases the sodium-ion conductivity and easily ensures high capacity. The molten salt electrolyte (or its cation) may contain an organic cation and an inorganic cation, as the third cation.

As the anion, a bis(sulfonyl)amide anion is preferably used. The bis(sulfonyl)amide anion may be appropriately selected from the anions exemplified for the organic electrolyte. Among bis(sulfonyl)amide anions, in particular, FSA and/or TFSA is preferred.

The ionic liquid contains a salt (second salt) of a sodium ion (second cation) and an anion (second anion) and may contain a salt (third salt) of the third cation and an anion (third anion), as needed. The second salt may be composed of a single type of salt or two or more types of salts having different second anions. The third salt may be composed of a single type of salt or two or more types of salts having different third cations and/or different third anions. The second and third anions may be appropriately selected from the foregoing anions.

Among the second salts, for example, a salt (Na.FSA) of a sodium ion and FSA, and/or a salt (Na.TFSA) of a sodium ion and TFSA is particularly preferred.

Specific examples of the third salt include a salt (Py13.FSA) of Py13 and FSA, a salt (Py13.TFSA) of PY13 and TFSA, a salt (Py14.FSA) of Py14 and FSA, a salt (Py14.TFSA) of PY14 and TFSA, a salt (BMI.FSA) of BMI and FSA, a salt (BMI.TFSA) of BMI and TFSA, a salt (EMI.FSA) of EMI and FSA, a salt (EMI.TFSA) of EMI and TFSA, a salt (TEMA.FSA) of TEMA and FSA, a salt (TEMA.TFSA) of TEMA and TFSA, a salt (TEA.FSA) of TEA and FSA, and a salt (TEA.TFSA) of TEA and TFSA. These third salts may be used separately or in combinations of two or more.

The proportion of the second salt in the total of the second salt and the third salt (i.e., the proportion of the sodium ion in the total of the sodium ion and the third cation) may be appropriately selected in the range of 5% to 95% by mole, depending on the type of salt.

In the case where the third cation is an organic cation, the proportion of the second salt is preferably 10% by mole or more, 15% by mole or more, 20% by mole or more, or 25% by mole or more, and more preferably 30% by mole or more or 40% by mole or more. The proportion of the second salt is preferably 65% by mole or less and more preferably 55% by mole or less. The molten salt electrolyte has relatively low viscosity, thus easily achieving high capacity. These lower limit values and the upper limit values may be freely combined together to set a preferred range. For example, the proportion of the second salt may be 10% to 65% by mole, 15% to 55% by mole, or 25% to 55% by mole.

The operating temperature of the sodium molten salt battery may be adjusted by the composition of the molten salt electrolyte. The sodium molten salt battery may operate in a wide temperature range of −20° C. to a temperature higher than 90° C.

The sodium ion secondary battery may be produced by, for example, (a) a step of forming an electrode group including a positive electrode, a negative electrode, and a separator provided between the positive electrode and the negative electrode and (b) a step of placing the electrode group and an electrolyte in a battery case.

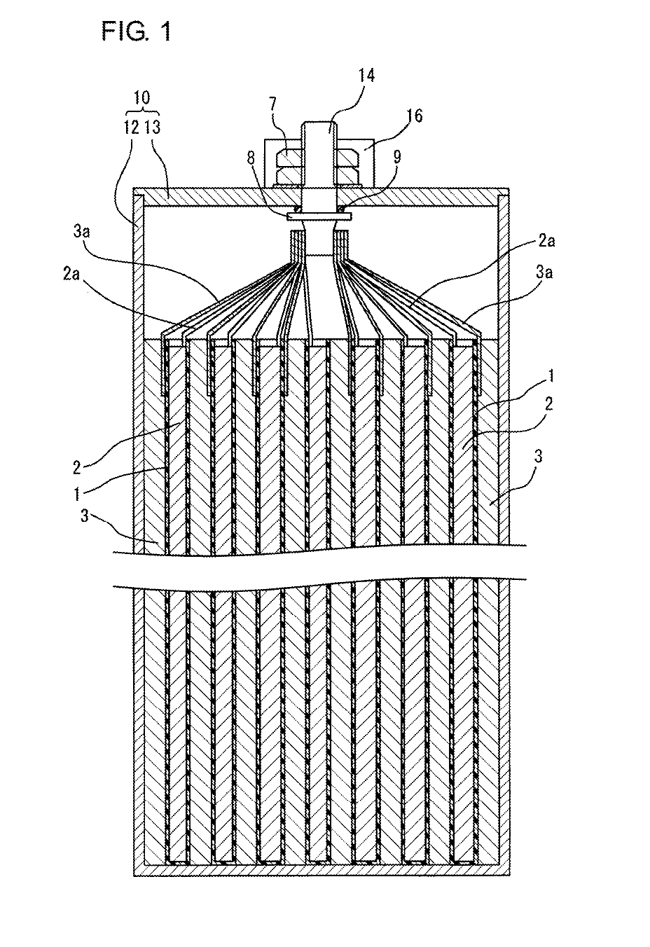

FIG. 1 is a longitudinal sectional view schematically illustrating a sodium ion secondary battery according to an embodiment of the present invention. The sodium ion secondary battery includes a stacked electrode group, an electrolyte (not illustrated), and a prismatic aluminum battery case 10 that accommodates these components. The battery case 10 includes a case main body 12 having an open top and a closed bottom; and a lid member 13 that closes the top opening.

When the sodium molten salt battery is assembled, positive electrodes 2 and negative electrodes 3 are stacked with separators 1 provided therebetween to form an electrode group, and the electrode group is inserted into the case main body 12 of the battery case 10. Then a step of filling gaps between the separators 1, the positive electrodes 2, and the negative electrodes 3 constituting the electrode group with an electrolyte is performed by charging an electrolyte into the case main body 12. Alternatively, when the electrolyte is a molten salt electrolyte, the electrode group may be impregnated with the molten salt electrolyte, and then the electrode group containing the molten salt electrolyte may be housed in the case main body 12.

A safety valve 16 that releases a gas to be generated inside when the internal pressure of the battery case 10 increases is provided in the middle of the lid member 13. An external positive electrode terminal 14 passing through the lid member 13 is provided on one side portion of the lid member 13 with respect to the safety valve 16. An external negative electrode terminal passing through the lid member 13 is provided on the other side portion of the lid member 13.

The stacked electrode group includes the plural positive electrodes 2, the plural negative electrodes 3, and the plural separators 1 provided therebetween, each of the positive electrodes 2 and the negative electrodes 3 having a rectangular sheet shape. In FIG. 1, each of the separators 1 has a bag form so as to surround a corresponding one of the positive electrodes 2. However, the form of each separator is not particularly limited. The plural positive electrodes 2 and the plural negative electrodes 3 are alternately stacked in the stacking direction in the electrode group.

A positive electrode lead strip 2a may be arranged on an end portion of each of the positive electrodes 2. The positive electrode lead strips 2a of the plural positive electrodes 2 are bundled and connected to the external positive electrode terminal 14 provided on the lid member 13 of the battery case 10, so that the plural positive electrodes 2 are connected in parallel. Similarly, a negative electrode lead strip 3a may be arranged on an end portion of each of the negative electrodes 3. The negative electrode lead strips 3a of the plural negative electrodes 3 are bundled and connected to the external negative electrode terminal provided on the lid member 13 of the battery case 10, so that the plural negative electrodes 3 are connected in parallel. The bundle of the positive electrode lead strips 2a and the bundle of the negative electrode lead strips 3a are preferably arranged on left and right sides of one end face of the electrode group with a distance kept between the bundles so as not to come into contact with each other.

Each of the external positive electrode terminal 14 and the external negative electrode terminal is columnar and has a screw groove at least in the externally exposed portion. A nut 7 is engaged with the screw groove of each terminal, and is screwed to secure the nut 7 to the lid member 13. A collar portion 8 is arranged in a portion of each terminal inside the battery case 10. Screwing the nut 7 allows the collar portion 8 to be secured to the inner surface of the lid member 13 with a washer 9.

The electrode group is not limited to the stack type and may be formed by winding a positive electrode and a negative electrode with a separator provided therebetween. From the viewpoint of preventing the deposition of metallic sodium on the negative electrode, the dimensions of the negative electrode may be larger than those of the positive electrode.

The charge and discharge of the sodium ion secondary battery are usually performed within a predetermined voltage range. Specifically, the sodium ion secondary battery is charged to a predetermined upper-limit voltage (charge cut-off voltage), and the sodium ion secondary battery is discharged to a predetermined final voltage (discharge cut-off voltage). The charge and discharge are typically controlled by a charge control unit and a discharge control unit in a charge-discharge system including the sodium ion secondary battery. An embodiment of the present invention includes a charge-discharge system including the sodium ion secondary battery, the charge control unit that controls the charge of the sodium ion secondary battery, and the discharge control unit that controls the discharge of the sodium ion secondary battery. The discharge control unit may include a loading device that consumes power supplied from the sodium ion secondary battery.

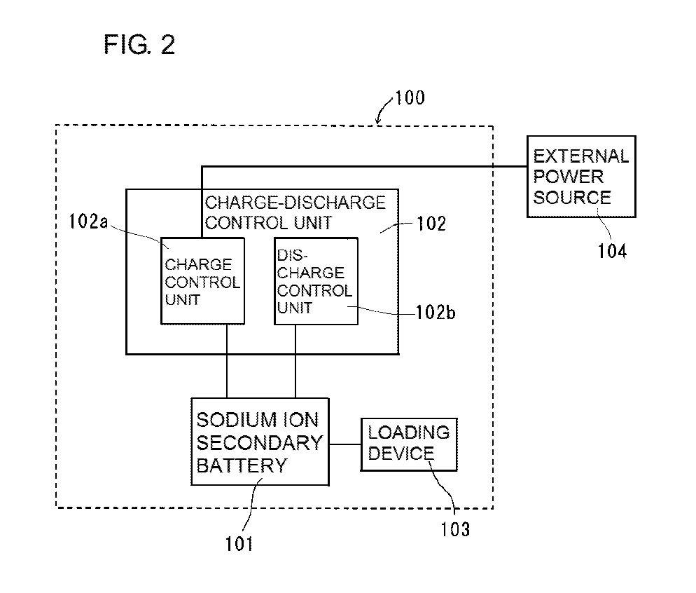

FIG. 2 is a block diagram schematically illustrating a charge-discharge system according to an embodiment of the present invention.

A charge-discharge system 100 includes a sodium ion secondary battery 101, a charge-discharge control unit 102 that controls the charge and discharge of the sodium ion secondary battery 101, and a loading device 103 that consumes power supplied from the sodium ion secondary battery 101. The charge-discharge control unit 102 includes a charge control unit 102a, for example, a current and/or a voltage during the charging of the sodium ion secondary battery 101 and a discharge control unit 102b that controls, for example, a current and/or a voltage during the discharge of the sodium ion secondary battery 101. The charge control unit 102a is connected to an external power source 104 and the sodium ion secondary battery 101. The discharge control unit 102b is connected to the sodium ion secondary battery 101. The loading device 103 is connected to the sodium ion secondary battery 101.

Regarding the foregoing embodiments, the following appendixes are further disclosed.

### APPENDIX 1

A sodium ion secondary battery includes

a positive electrode containing a positive electrode active material, a negative electrode containing a negative electrode active material, a separator provided between the positive electrode and the negative electrode, and an electrolyte,

the electrolyte being a nonaqueous electrolyte containing sodium ions,

the positive electrode active material containing a sodium-containing transition metal oxide that reversibly intercalates and deintercalates sodium ions,

the negative electrode active material containing at least one selected from the group consisting of a first material that reversibly intercalates and deintercalates sodium ions and a second material that is alloyed with sodium,

in the sodium-containing transition metal oxide in a fully charged state, the ratio of sodium atoms to transition metal atoms, i.e., Na/M_{T}, satisfying Na/M_{T}≦0.3, and

the ratio of the total Cₙₜ of the reversible capacity and the irreversible capacity of the negative electrode to the total Cₚₜ of the reversible capacity and the irreversible capacity of the positive electrode, i.e., Cₙₜ/Cₚₜ, satisfying 1≦Cₙₜ/Cₚₜ.

In the battery according to Appendix 1, the deposition of sodium is inhibited even during overcharge.

### APPENDIX 2

In the sodium ion secondary battery according to Appendix 1, the sodium-containing transition metal oxide contains a compound represented by formula (1): NaₓTi_{y}Ni_{z}Mn_{1-y-z}O₂ (where x varies by charge and discharge and satisfies 0≦x≦0.67; 0.15≦y≦0.2; and 0.3≦z≦0.35), and the ratio Cₙₜ/Cₚₜ satisfies 1≦Cₙₜ/Cₚₜ≦1.3.

In this case, high resistance to overcharge is ensured, and the energy density is further increased.

### APPENDIX 3

A charge-discharge system includes the sodium ion secondary battery described in Appendix 1 or 2, a charge control unit that controls the charge of the sodium ion secondary battery, and a discharge control unit that controls the discharge of the sodium ion secondary battery.

In the charge-discharge system, even when the sodium ion secondary battery is in an overcharged state, the deposition of sodium is inhibited.

### EXAMPLES

The present invention will be specifically described below on the basis of examples and comparative examples. However, the present invention is not limited to these examples described below.

### Example 1

(1) Synthesis of Sodium-Containing Transition Metal Oxide Na_{2/3}Ti_{1/6}Ni_{1/3}Mn_{1/2}O₂

Sodium carbonate, nickel hydroxide, titanium oxide, and manganese carbonate were mixed together in a ratio such that the resulting sodium-containing transition metal oxide had the foregoing composition. The resulting mixture was fired in an air atmosphere at 900° C. for 12 hours to synthesize Na_{2/3}Ti_{1/6}Ni_{1/3}Mn_{1/2}O₂. The composition of the fired product was identified by an X-ray diffraction spectrum.

### (2) Production of Positive Electrode

Na_{2/3}Ti_{1/6}Ni_{1/3}Mn_{1/2}O₂ (positive electrode active material) prepared in (1), acetylene black (conductive assistant), and polyvinylidene fluoride (binder) were mixed together with NMP to prepare a positive electrode mixture paste. In this case, the ratio by mass of the positive electrode active material to the conductive assistant to the binder was 100:10:5. The positive electrode mixture paste was applied to a surface of aluminum foil having a thickness of 20 μm, sufficiently dried, and pressed to produce a positive electrode having a thickness of about 52 μm. The positive electrode was punched into a coin form having a diameter of 12 mm.

### (3) Production of Negative Electrode

First, 100 parts by mass of hard carbon (negative electrode active material) and 4 parts by mass of polyvinylidene fluoride (binder (binding agent)) were mixed together with N-methyl-2-pyrrolidone to prepare a negative electrode mixture paste. The resulting negative electrode mixture paste was applied to a surface of copper foil having a thickness of 20 μm, sufficiently dried, and pressed to produce a negative electrode having a thickness of 100 μm. The negative electrode was punched into a coin form having a diameter of 12 mm.

### (4) Production of Sodium Molten Salt Battery

The positive electrode, the negative electrode, and the separator that had the coin form were heated at a reduced pressure of 0.3 Pa and 90° C. or higher and thus sufficiently dried. Subsequently, the coin-formed negative electrode was placed in a shallow cylindrical Al/stainless steel-clad case. The coin-formed positive electrode was placed thereon with the coin-formed separator provided therebetween. A predetermined amount of a molten salt electrolyte was injected into the case. Then the opening of the case was sealed with a shallow cylindrical Al/stainless steel-clad sealing plate having an insulating gasket at its circumference. As a result, a pressure is applied to an electrode group including the negative electrode, the separator, and the positive electrode between the bottom of the case and the sealing plate, bringing the components into contact with each other. Thereby, a coin-formed sodium molten salt battery A1 was produced. As the separator, a microporous membrane composed of polyolefin (NPS, 50 μm thick, manufactured by Nippon Sheet Glass Co., Ltd.) was used. As the molten salt electrolyte, 0.014 g of ionic liquid (the ionic liquid content of the molten salt electrolyte: 100% by mass) containing Na.FSA and Py13.FSA in a molar ratio of 40:60 was used. Cₑ was determined from the total number of sodium ions contained in the molten salt electrolyte used and found to be 0.69 mAh.

(5) Evaluation

(a) Cₚₜ, Cₙₜ/Cₚₜ, and Cₙₜ/(Cₚₜ+Cₑ)

A sodium molten salt battery (half cell) was produced as in (4), except that the negative electrode produced in (3) and a sodium electrode serving as a counter electrode were used. As the sodium electrode, a coin-formed electrode (thickness: 50 μm, diameter: 12 mm) in which metallic sodium was bonded to aluminum foil was used. The resulting half cell was maintained at 25° C. A cycle in which the cell was charged to 0.02 V at 0.1 C and then discharged to 1.5 V at 0.1 C was repeated twice, thereby determining the reversible capacity and the irreversible capacity of the negative electrode. The total Cₙₜ thereof was calculated.

The total Cₚₜ of the reversible capacity and the irreversible capacity of the positive electrode was calculated as capacity at the time when all sodium atoms were deintercalated from the positive electrode. The ratio Na/M_{T} corresponding to the capacity of a portion of the produced positive electrode where charge and discharge cannot be reversibly performed is 0.1.

Cₙₜ/Cₚₜ and Cₙₜ/(Cₚₜ+Cₑ) were calculated from Cₙₜ, Cₚₜ, and Cₑ values.

### (b) Energy Density

The sodium molten salt battery produced in (4) was maintained at 25° C. Charge and discharge were performed using a charge-discharge cycle in which the battery was charged to a charge cut-off voltage (4.0 V) at 0.1 C, the charge cut-off voltage being set in such a manner that the ratio Na/M_{T} at a state of charge (SOC) of 100% was a predetermined value (0.3 in Example 1), and discharged to 2.0 V at 0.1 C. The discharge capacity at the first cycle (initial battery capacity) was determined. The initial capacity (Ah) was divided by the total volume (L) of the positive electrode, the negative electrode, and the separator to determine the energy density (Ah/L). The volume (apparent volume) of the positive electrode and the negative electrode was calculated from the size thereof

(c) Test for resistance to overcharge

The sodium molten salt battery produced in (4) was charged at 25° C. to a fully charged state (SOC: 100%). The battery was over-charged from the fully charged state at 0.5 C for 4 hours while the battery temperature was measured. The maximum battery temperature (maximum temperature) (° C.) during overcharge was determined.

### Example 2

A positive electrode was produced as in Example 1, except that the thickness of the positive electrode was changed as listed in Table 1 by adjusting the amount of the positive electrode mixture paste applied. A sodium molten salt battery A2 was produced as in Example 1, except that the resulting positive electrode was used. The evaluations were performed. In this case, however, the ratio Na/M_{T} at a state of charge (SOC) of 100% was changed to 0.1. Thus, the charge cut-off voltage was set to 4.3 V in the evaluation of the energy density.

### Comparative Example 1

A positive electrode was produced as in Example 1, except that sodium chromite was used in place of Na_{2/3}Ti_{1/6}Ni_{1/3}Mn_{1/2}O₂. A sodium molten salt battery B1 was produced as in Example 1, except that the resulting positive electrode was used. The evaluations were performed. In this case, however, the ratio Na/M_{T} of sodium chromite in a fully charged state is 0.5. Thus, in the evaluation of the energy density, the charge cut-off voltage was set to 3.5 V in such a manner that the ratio Na/M_{T} at a state of charge (SOC) of 100% was 0.5. The ratio Na/M_{T} corresponding to the capacity of a portion of the produced positive electrode where charge and discharge cannot be reversibly performed is 0.5.

### Comparative Example 2

A positive electrode was produced as in Comparative example 1, except that the thickness of the positive electrode was changed as listed in Table 1 by adjusting the amount of the positive electrode mixture paste applied. A sodium molten salt battery B2 was produced as in Comparative example 1, except that the resulting positive electrode was used. The evaluations were performed.

### Comparative Example 3

A positive electrode was produced as in Example 1, except that the thickness of the positive electrode was changed as listed in Table 1 by adjusting the amount of the positive electrode mixture paste applied. A sodium molten salt battery B3 was produced as in Example 1, except that the resulting positive electrode was used. The evaluations were performed.

Table 1 lists the results of the examples and the comparative examples.

TABLE 1

| | Specification of battery | | | | | | | Battery characteristics | |
|---|---|---|---|---|---|---|---|---|---|
| | | | Thickness of | | Thickness of | | | Energy | |
| | Positive electrode | Ratio Na/M_{T} | positive | Cₚₜ | negative | | | density | Resistance to |
| Battery | active material | SOC = 100% | electrode (μm) | (mAh) | electrode (μm) | Cₙₜ/Cₚₜ | Cₙₜ/(Cₚₜ + Cₐ) | (Ah/L) | overcharge (° C.) |
| A1 | Na_{2/3}Ti_{1/6}Ni_{1/3}Mn_{1/2}O₂ | 0.3 | 51.8 | 2.78 | 100 | 1.25 | 1.00 | 56.9 | 40 |
| A2 | Na_{2/3}Ti_{1/6}Ni_{1/3}Mn_{1/2}O₂ | 0.1 | 66.6 | 2.78 | 100 | 1.25 | 1.00 | 68.9 | 39 |
| B1 | NaCrO₂ | 0.5 | 60.0 | 4.50 | 100 | 0.77 | 0.67 | 63.7 | >180 |
| B2 | NaCrO₂ | 0.5 | 46.3 | 3.47 | 100 | 1.00 | 0.83 | 52.0 | 85 |
| B3 | Na_{2/3}Ti_{1/6}Ni_{1/3}Mn_{1/2}O₂ | 0.3 | 77.1 | 4.13 | 100 | 0.84 | 0.72 | 76.6 | >180 |

As listed in Table 1, the results of the batteries A1 and A2 according to the examples in which the ratio Cₙₜ/Cₚₜ was 1 or more demonstrated the following: The batteries had high energy density. The increase in battery temperature was inhibited even during overcharge. That is, the batteries had good resistance to overcharge.

The results of the batteries B1 and B3 according to the comparative examples in which the ratio Cₙₜ/Cₚₜ was less than 1 demonstrated that although the batteries had high energy density to a certain extent, the battery temperature during overcharge was higher than 180° C. That is, the batteries had significantly low resistance to overcharge. In the battery B2 according to the comparative example, although the ratio Cₙₜ/Cₚₜ was 1 or more, the ratio Na/M_{T} in a fully charged state was more than 0.3. The positive electrode had large irreversible capacity. The battery had low energy density. Furthermore, in the battery B2, the battery temperature was increased to 85° C.

In the batteries B1 to B3 according to the comparative examples, the reason the battery temperature during overcharge was increased is presumably that sodium was deposited on the negative electrode during overcharge to cause an internal short-circuit between the positive electrode and the negative electrode.

### INDUSTRIAL APPLICABILITY

The sodium ion secondary battery according to an embodiment of the present invention has good resistance to overcharge and thus is useful for, for example, large-scale power storage apparatuses for household and industrial use and power sources for electric vehicles and hybrid vehicles.

### REFERENCE SIGNS LIST

1 separator
2 positive electrode
2a positive electrode lead strip
3 negative electrode
3a negative electrode lead strip
7 nut
8 collar portion
9 washer
10 battery case
12 case main body
13 lid member
14 external positive electrode terminal
16 safety valve
100 charge-discharge system
101 sodium ion secondary battery
102 charge-discharge control unit
102a charge control unit
102b discharge control unit
103 loading device
104 external power source

1. A sodium ion secondary battery comprising:
a positive electrode containing a positive electrode active material, a negative electrode containing a negative electrode active material, a separator provided between the positive electrode and the negative electrode, and an electrolyte,
the electrolyte being a nonaqueous electrolyte containing sodium ions,
the positive electrode active material containing a sodium-containing transition metal oxide that reversibly intercalates and deintercalates sodium ions,
the negative electrode active material containing at least one selected from the group consisting of a first material that reversibly intercalates and deintercalates sodium ions and a second material that is alloyed with sodium,
in the sodium-containing transition metal oxide in a fully charged state, the ratio of sodium atoms to transition metal atoms, i.e., Na/M_{T}, satisfying Na/M_{T}≦0.3, and
the ratio of the total Cₙₜ of the reversible capacity and the irreversible capacity of the negative electrode to the total Cₚₜ of the reversible capacity and the irreversible capacity of the positive electrode, i.e., Cₙₜ/Cₚₜ, satisfying 1≦Cₙₜ/Cₚₜ.

2. The sodium ion secondary battery according to claim 1, wherein the sodium-containing transition metal oxide contains Ni, Ti, and Mn as the transition metal atoms.

3. The sodium ion secondary battery according to claim 1, wherein the sodium-containing transition metal oxide comprises a compound represented by formula (1): NaₓTi_{y}Ni_{z}Mn_{1-y-z}O₂ (where x varies by charge and discharge and satisfies 0≦x≦0.67; 0.15≦y≦0.2; and 0.3≦z≦0.35).

4. The sodium ion secondary battery according to claim 1, wherein the ratio Cₙₜ/Cₚₜ satisfies 1≦Cₙₜ/Cₚₜ≦1.3.

5. The sodium ion secondary battery according to claim 1, wherein when a capacity corresponding to the total number of sodium ions contained in the electrolyte is expressed as Cₑ, Cₙₜ satisfies Cₙₜ≧(Cₚₜ+Cₑ).

6. The sodium ion secondary battery according to claim 1, wherein the electrolyte contains 70% by mass or more of an ionic liquid, and the ionic liquid contains an anion and a sodium ion.

7. The sodium ion secondary battery according to claim 1, wherein the first material is at least one selected from the group consisting of soft carbon, hard carbon, and alkali metal-containing titanium oxide, and
the second material contains at least one selected from the group consisting of zinc, indium, tin, silicon, phosphorus, antimony, lead, and bismuth.
